(19) United States
(12) Patent Application Publication
(10) Pub. No.: US 2003/0227230 A1
(43) Pub. Date: Dec. 11, 2003

(54) Exterior winding strategy for salient pole brushless motor for fuel pump application

(76) Inventor: Daniel Gizaw, DEARBORN, MI (US)

Correspondence Address: BRINKS HOFER GILSON & LIONE, P.O. BOX 10395, CHICAGO, IL, 60611, US

(21) Appl. No.: 10/159,990

(22) Filed: May 29, 2002

Related U.S. Application Data
(60) Provisional application No. 60/316,179, filed on Aug. 31, 2001.

(51) Int. Cl. H02K 1/18

(52) U.S. Cl. 310/218

(57) ABSTRACT

Provided is a stator for a motor including a plurality of spokes wound with wire before assembly of the stator. The spokes are engaged with an inner and outer stator frame, and a stator housing is mounted over the outer stator frame. Also provided is a method for production of a stator for a motor including providing a plurality of spokes and winding each spoke individually with a wire. The spokes are then inserted into an inner stator frame and attached to an outer stator frame.

### BACKGROUND OF THE INVENTION

A multi-phase salient motor is often used in vehicle systems, most often in the fuel pump. The multi-phase salient pole motor includes a rotor having magnets positioned at the ends of arms and a stator comprising a plurality of electromagnets. The electromagnets on the stator are on spokes of the stator. The stator spokes are wound with wire, and electricity run through the wire to create a magnetic field.

The winding of the spokes has been difficult to accomplish in a manner conducive to mass production. The stator must be wound tightly and each spoke has only a small open space between them. Winding the spokes in the assembled stator increases manufacturing cost as well as the manufacturing time, which is ineffective for mass production of the motor.

### BRIEF SUMMARY OF THE INVENTION

According to one embodiment of the present invention, there is provided a stator for a motor. The stator includes a plurality of spokes, at least one of the spokes each having a first end and a second end, where the first end is engaged with an inner stator frame and the second end is engaged with an outer stator frame. The spokes are wound with wire external to the two stator frames. A stator housing is mounted over the outer stator frame.

According to another embodiment of the present invention, there is provided a method for production of a stator for a motor including providing a plurality of spokes and winding each spoke individually with a wire. The spokes are inserted into an inner stator frame and attached to an outer stator frame.

Other aspects of the present invention will become apparent in connection with the following description of the present invention.

### BRIEF DESCRIPTION OF SEVERAL VIEWS OF THE DRAWINGS

FIG. 1 is a view of an assembled stator according to one embodiment of the present invention, with a portion of the stator housing removed;

FIG. 2 is a view of multiple spokes of the embodiment of FIG. 1 being wound according to the present invention;

FIG. 3 is a flow diagram of a preferred embodiment of the present invention; and

FIG. 4 is a magnified view of the outer stator frame of the embodiment of FIG. 1 depicting one preferred geometry of crimping according to the present invention.

### DETAILED DESCRIPTION OF THE INVENTION

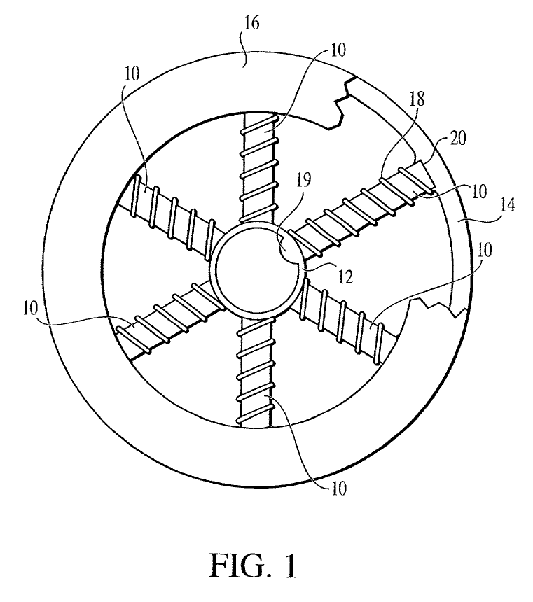

An assembled stator according to one embodiment of the present invention is depicted in FIG. 1. The stator includes a plurality of spokes 10, an inner stator frame 12, an outer stator frame 14, and a stator housing 16. The stator components are preferably made of metal, such as a silicon steel, and more preferably M49 silicon steel or M19 silicon steel. Other materials having good magnetic properties may also be used.

The spokes 10 are preferably of identical or similar geometry, but may differ from each other. Preferably, the spokes 10 have a rectangular prism shape, such as a rectangular prism with a square base and cross-section. Cylindrical or other cross-section geometries may also be used for the spokes 10. Each spoke 10 has a first end at one base and a second end directly opposite the first end.

Both the inner stator frame 12 and the outer stator frame 14 are preferably circular, and the inner stator frame 12 has a smaller radius than the outer stator frame 14. Other shapes may be used. In a preferred embodiment, the difference between the radius of the outer stator frame 14 and the inner stator frame 12 is about the length of a spoke 10. Preferably, the inner stator frame 12 comprises a number of indentations 19. These indentations 19 are designed to snugly hold one of the ends of the spoke 10.

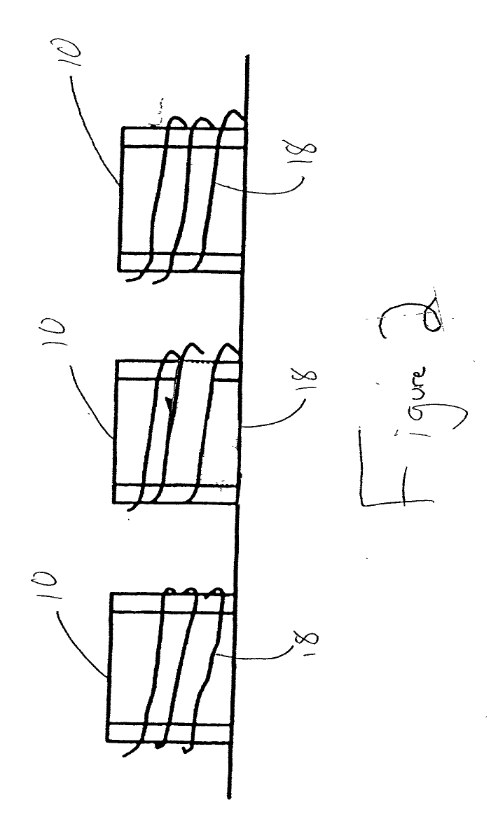

The winding process is shown in FIG. 2. The spokes 10 are individually wound external to the stator. Winding of the spokes 10 before installation into the stator allows for faster and more efficient production. Instead of requiring special equipment to thread through the spaces between spokes 10 in an assembled stator, a more conventional winding apparatus as known to those of skill in the art may be used. Further, the winding may be done more precisely, tightly, and uniformly. Precise and uniform winding of the wire 18 on the spokes 10 produces more reliable stators.

The wire 18 is made of any electrically conductive material, such as copper. At the time of winding, any additional wire modification to improve the conductivity can be performed. For example, wire ends may be fitted with connectors, or insulation taken off the ends.

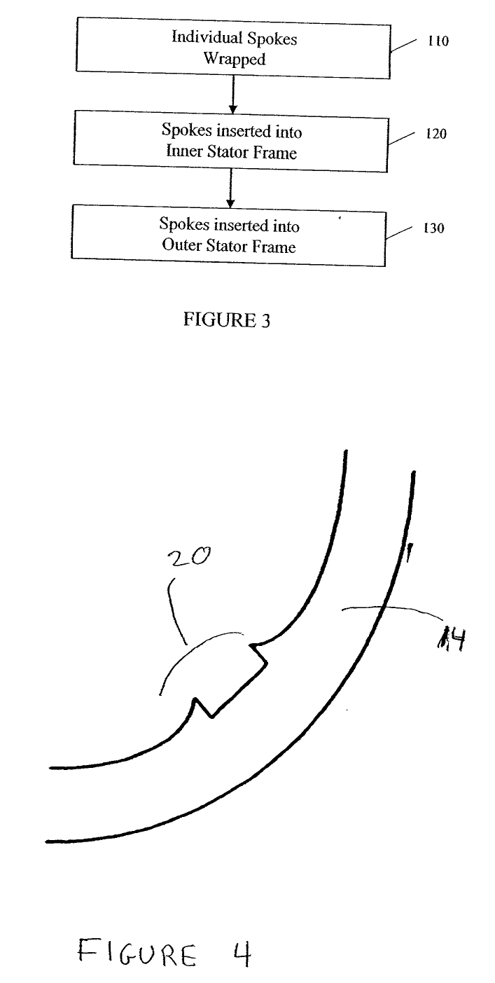

FIG. 3 shows a flow diagram of a preferred embodiment of the present invention. The spokes 10 are first wound with wire 18 before insertion into the stator at Box 110. The spokes 10 wound with wire 18 are then inserted into the inner stator frame 12 at Box 120. Preferably, the inner stator frame 12 comprises indentations 19 to hold the first ends of the spokes 10 in place. According to one preferred embodiment of the present invention, the spokes 10 are additionally secured to the inner stator frame 12 by an adhesive or by 20 welding. The adhesive used may be any one known to promote metal-to-metal bonding. A snap fit, latch, or other connection may be used, on its own or in connection with welding or an adhesive. The spokes 10 are preferably arranged at equidistant intervals circumferentially around the inner stator. Wires 18 may also be connected to the inner stator frame 12 or to wires 18 on other spokes 10.

The spokes 10 wound with wire 18 and mounted on the inner stator frame 12 are then pressed into the outer stator frame 14 at Box 130. Preferably, the outer stator frame 14 comprises indentations to hold the second ends of said spokes 10 in place. For example, the outer stator frame 14 has crimpings 20, as shown in FIG. 4, allowing the spokes 10 and inner stator frame 12 to be easily pressed into the outer stator frame 14. These crimpings 20 are indentations designed to allow the spoke 10 to be easily inserted while stabilizing and securing the spoke 10. FIG. 4 illustrates one preferred embodiment of these crimpings 20. Spokes 10 as mounted in a finished stator frame are depicted in FIG. 1. Other crimping geometries that also facilitate the joining of the spokes 10 to the outer stator frame 14 are possible. Preferably, these crimpings 20 are arranged on the outer stator frame 14 so as to be equidistant from each other along the circumference and to align with the spokes 10. In one preferred embodiment, the connection between the spokes 10 and the outer stator frame 14 at the crimping 20 is strengthened by welding the two parts together or by using an adhesive. The adhesive used may be any one known in the art to promote metal-to-metal bonding. Wires 18 may also be connected to the outer stator frame 14 or to wires 18 on other spokes 10.

Alternatively, the spokes 10 may be pressed into the outer stator frame 14 at Box 130 before being pressed into the inner stator frame 12 at Box 120. In such a method, the crimpings 20 may remain on the outer stator 14, or be placed on the inner stator frame 12.

In a second embodiment, an additional stator housing 16 is mounted over the assembled stator, as shown in FIG. 1. The stator housing 16 is a cover for the stator, and is mounted on top of the outer stator frame 14. The stator housing 16 may then be pressed, crimped, welded, or otherwise attached to the outer stator frame 14. An adhesive may also be used. The adhesive used may be any type known to promote metal-to-metal bonding. Further, a snap fit, latch, or other connection may be used, on its own or in connection with welding or an adhesive.

The embodiments shown in the present invention are to be considered as illustrative and not restrictive, and the invention is not to be limited to the details given herein, but may be modified within the scope of the following claims.

1. A method for production of a stator for a motor comprising:
providing a plurality of spokes;
winding each spoke individually with a wire; and
inserting said spokes into an inner stator frame;
attaching said spokes into an outer stator frame.

2. The method of claim 1, wherein attaching said spokes into said inner stator frame comprises pressing said spokes into an indentation in said inner stator frame at the point of attachment.

3. The method of claim 1, wherein attaching said spokes into said outer stator frame comprises pressing said spokes into a crimped area in said outer stator frame at the point of attachment.

4. The method of claim 1, further comprising welding said spokes to said inner stator frame and said outer stator frame.

5. The method of claim 1, further comprising adhering said spokes to said inner stator frame and said outer stator frame with an adhesive.

6. The method of claim 1, further comprising mounting a stator housing on said outer stator frame.

7. The method of claim 6, wherein mounting said stator housing comprises welding said stator housing to said outer stator frame.

8. The method of claim 6, wherein mounting said stator housing comprises adhering said stator housing to said outer stator frame with an adhesive.

9. A stator for a motor comprising:
a plurality of spokes having a first end and a second end;
an inner stator frame engaged with said first ends of said spokes;
an outer stator frame, concentric with said inner stator frame, engaged with said second ends of said spokes;
wire wrapped around each spoke; and
a stator housing mounted over said outer stator frame.

10. The stator of claim 9 wherein said spokes are made from a silicon steel.

11. The stator of claim 10 wherein said silicon steel is selected from the group consisting of M49 silicon steel and M19 silicon steel.

12. The stator of claim 9 wherein the cross-sectional shape of said spokes is selected from the group consisting of a rectangular prism shape and a cylindrical shape.

13. The stator of claim 12 wherein said cross-sectional shape is the rectangular prism shape with a square base.

14. The stator of claim 9 wherein said inner stator frame and said outer stator frame are made of a silicon metal selected from the group consisting of M49 silicon steel and M19 silicon steel.

15. The stator of claim 9 wherein said outer stator housing is made of a silicon metal selected from the group consisting of M49 silicon steel and M19 silicon steel.

16. The stator of claim 9 wherein said outer stator frame further comprises a plurality of crimpings for engagement with the spokes.

17. The stator of claim 16 wherein said crimpings are circumferentially equidistant from each other.

18. The stator of claim 9 wherein said engagement between said spokes and said inner stator frame comprises a welded connection.

19. The stator of claim 9 wherein said engagement between said spokes and said outer stator frame comprises an adhesive.

20. The stator of claim 9 wherein said mounting between said outer stator frame and said stator housing comprises a welded connection.

21. The stator of claim 9 wherein said mounting between said outer stator frame and said stator housing comprises an adhesive.
